(19) United States
(12) Patent Application Publication
(10) Pub. No.: US 2012/0317979 A1
(43) Pub. Date: Dec. 20, 2012

(54) ARRANGEMENT OF TWO INDEPENDENTLY OPERATED TURBOCHARGERS FOR A COMBUSTION ENGINE, AND METHOD OF OPERATING THE TWO TURBOCHARGERS

(75) Inventors: ABDULLAH ADAMOL, Heilbronn (DE); Heiko SCHWÄMMLE, Offenau (DE)

(73) Assignee: Audi AG, Ingolstadt (DE)

(21) Appl. No.: 13/328,301

(22) Filed: Dec. 16, 2011

(30) Foreign Application Priority Data
Dec. 17, 2010 (DE) 10 2010 054 959.2

(51) Int. Cl. F02B 37/12; F02B 37/00

(52) U.S. Cl. 60/612; 417/53

(57) ABSTRACT

A combustion engine includes two turbochargers which operate independently from one another. Each of the turbochargers is supplied with air via a clean-air pipe with the assistance of a clean-air filter. A device provides pressure equalization between air in the clean-air pipe of one of the turbochargers and the clean-air pipe of the other one of the turbochargers.

### CROSS-REFERENCES TO RELATED APPLICATIONS

This application claims the priority of German Patent Application, Serial No. 10 2010 054 959.2, filed Dec. 17, 2010 pursuant to 35 U.S.C. 119(a)-(d), the content of which is incorporated herein by reference in its entirety as if fully set forth herein.

### BACKGROUND OF THE INVENTION

The present invention relates to an arrangement of a combustion engine and two independently operating turbochargers operably connected to the combustion engine.

The following discussion of related art is provided to assist the reader in understanding the advantages of the invention, and is not to be construed as an admission that this related art is prior art to this invention.

It is generally known in the art to equip motor vehicles with a turbocharger assembly, in which each turbocharger feeds charge air to a group of combustion chambers. The group may be in particular a cylinder bank. Filtered air is fed to the turbochargers via a clean-air pipe, whereby a separate clean-air filter is provided for each turbocharger and thus each clean-air pipe.

An example of a conventional arrangement of a combustion engine with two turbochargers operating independently from one another is shown in FIG. 1. The combustion engine has two cylinder banks 10a, 10b, with cylinder bank 10a having four cylinders 12a and cylinder bank 10b having four cylinders 12b. A turbocharger 14a is operably connected to the cylinder bank 10a, and a turbocharger 14b is operably connected to the cylinder bank 10b. The turbochargers 14a, 14b are provided to push filtered air (clean air) into the cylinders 12a, 12b, thereby utilizing the pressure of exhaust exiting the cylinders. A clean-air filter 16a is hereby provided for the turbocharger 14a and connected thereto by a clean-air pipe 18a, and a clean-air filter 16b is provided for the turbocharger 14b and connected thereto by a clean-air pipe 18b. Air (charge air) compressed by the turbochargers 14a, 14b is then fed via conduits 20a, 20b to the cylinders 12a, 12b, respectively. Exhaust-gas recirculation pipes 22a, 22b feed exhaust gas to the turbochargers 14a, 14b, respectively.

The turbochargers 14a, 14b operate independently from one another in the absence of any connection between the clean-air pipes 18a, 18b. Typically, constraints of installation space for example require different configurations or shapes between the clean-air pipes 18a, 18b. As shown in FIG. 1 by way of example, the clean-air pipe 18b is longer than the clean-air pipe 18a. In such a situation, air pressure of clean air in the clean-air pipe 18a differs from the air pressure of clean air in the clean-air pipe, 18b. For example, the air pressure of clean air in the clean-air pipe 18a is smaller than the air pressure of clean air in the clean-air pipe 18b. As a consequence, the turbocharger 14a has to provide more power and thus is exposed to greater wear than the turbocharger 14b. In other words, the turbocharger 14a must be replaced earlier, i.e. the turbochargers 14a, 14b will be replaced at different times, requiring two procedures of replacement. As an alternative, both turbochargers can be replaced at the same time, although the turbocharger 14b has not yet reached the end of its service life. In either case, operating costs are significantly increased.

It would therefore be desirable and advantageous to address these problems and to obviate other prior art shortcomings.

### SUMMARY OF THE INVENTION

According to one aspect of the present invention, an arrangement includes a combustion engine having two turbochargers operating independently from one another, each of the turbochargers being supplied with air via a clean-air pipe with the assistance of a clean-air filter, and a device for providing pressure equalization between air in the clean-air pipe of one of the turbochargers and the clean-air pipe of the other one of the turbochargers.

The present invention resolves prior art problems by providing pressure equalization in flow direction of air upstream of the turbochargers. This is based on the recognition that different pressures in different clean-air pipes cause different output of the turbochargers, resulting in different thermal stress and different wear. As a pressure difference may last continuously, especially in view of differences in shape between the two clean-air pipes, one turbocharger wears off more rapidly than the other turbocharger. As a result, the one turbocharger requires premature replacement, and for expediency the other turbocharger will also be replaced, even though this turbocharger is not worn off as of yet. Due to pressure equalization in accordance with the present invention, wear is not only reduced overall but also more evenly dispersed. In other words, when one turbocharger has to be replaced because of wear, the other turbocharger is also likely worn off and thus needs to be replaced as well, thereby keeping overall costs to a minimum.

According to another advantageous feature of the present invention, the device can be constructed to permit a transfer of air from the clean-air pipe of one of the turbochargers to the clean-air pipe of the other one of the turbochargers. Thus, air is transferred from the clean-air pipe where air pressure is higher to the clean-air pipe where the air pressure is lower. Pressure equalization may take place simply by air itself, allowing a simple implementation of the device.

According to another advantageous feature of the present invention, the device may include a fluid conduit to provide a communication between the clean-air pipe of one of the turbochargers and the clean-air pipe of the other one of the turbochargers. The fluid conduit can be configured such that pressure waves can develop or a pressure gradient may be established, when the turbocharger operates at normal rotational speeds and in the presence of typical pressure differences.

According to another advantageous feature of the present invention, the device may include, as an alternative, a plenum chamber in communication with the clean-air pipe of one of the turbochargers and the clean-air pipe of the other one of the turbochargers. The plenum chamber is able to hold a greater air amount compared to the afore-described fluid conduit, so that the pressure equalization may be realized by an air mass flow by way of laminar or, optionally, turbulent flow.

According to another aspect of the present invention, a method of operating two turbochargers in an arrangement with a combustion engine includes feeding clean air to each of the two turbochargers from a separate clean-air filter, and equalizing a pressure of clean air fed to the turbochargers. As a result, wear can be reduced overall and more evenly affect both turbochargers.

According to another advantageous feature of the present invention, the equalizing step may be realized using pressure waves or by using an air mass flow.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a conventional arrangement of a combustion engine with two turbochargers operating independently from one another;

FIG. 2 is a schematic illustration of one embodiment of an arrangement of a combustion engine with two turbochargers operating independently from one another in accordance with the present invention; and

FIG. 3 is a schematic illustration of another embodiment of an arrangement of a combustion engine with two turbochargers operating independently from one another in accordance with the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

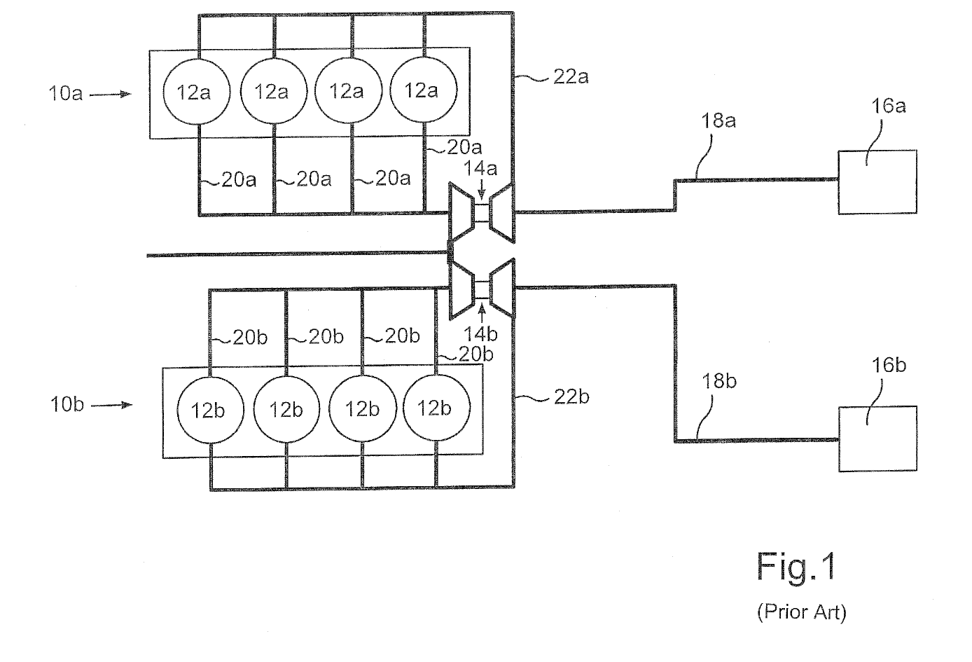

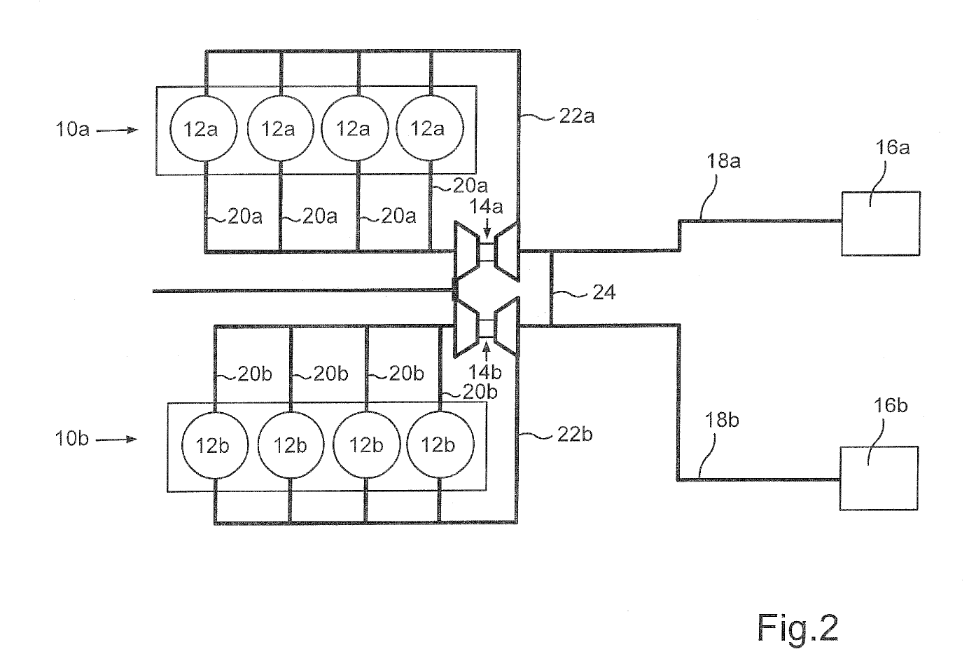

Turning now to the drawing, and in particular to FIG. 2, there is shown a schematic illustration of one embodiment of an arrangement of a combustion engine with two turbochargers operating independently from one another in accordance with the present invention. Parts corresponding with those in FIG. 1 are denoted by identical reference numerals and not explained again. In the embodiment of FIG. 2, provision is made for a transfer conduit 24, also called “cross-talk conduit”, which provides a fluidic communication between the two clean-air pipes 18a, 18b to realize pressure equalization between clean air in the clean-air pipe 18a and clean air in the clean-air pipe 18b. Pressure equalization may hereby be established by pressure waves which may form as a standing wave in the transfer pipe 24 in particular.

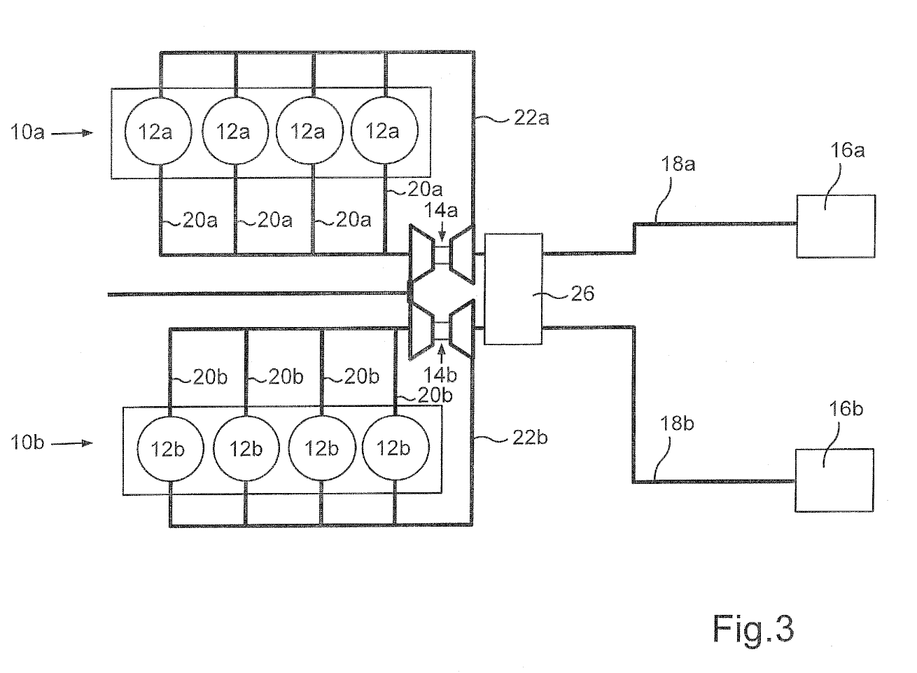

FIG. 3 shows a schematic illustration of another embodiment of an arrangement of a combustion engine with two turbochargers operating independently from one another in accordance with the present invention. Parts corresponding with those in FIG. 2 are denoted by identical reference numerals and not explained again. In the embodiment of FIG. 3, provision is made for a plenum chamber 26 instead of a transfer conduit, with the plenum chamber 24 sized to allow a laminar (or optionally turbulent) flow of air from the clean-air pipe 18b to the clean-air pipe 18a.

The pressure equalization via the transfer conduit 24, as shown in FIG. 2, or via the plenum chamber 24, as shown in FIG. 3, ensures that both turbochargers 14a, 14b are acted upon by same pressure and exposed to comparable wear so that the turbochargers 14a, 14b reach more or less the end of their service life at the same time and thus need to be replaced basically at the same time. In other words, both turbochargers 14a, 14b can essentially be operated to the maximum of their service life.

Although FIGS. 2 and 3 show the presence of two separate clean-air filters 16a, 16, it is of course, also conceivable to provide a common clean-air filter for supply of filtered clean air to both clean-air pipes 18a, 18b.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. In combination:
a combustion engine having two turbochargers operating independently from one another, each of the turbochargers being supplied with air via a clean-air pipe with the assistance of a clean-air filter; and
a device for providing pressure equalization between air in the clean-air pipe of one of the turbochargers and the clean-air pipe of the other one of the turbochargers.

2. The combination of claim 1, wherein the device is constructed to permit a transfer of air from the clean-air pipe of the one of the turbochargers to the clean-air pipe of the other one of the turbochargers.

3. The combination of claim 2, wherein the device includes a fluid conduit to provide a communication between the clean-air pipe of the one of the turbochargers and the clean-air pipe of the other one of the turbochargers.

4. The combination of claim 2, wherein the device includes a plenum chamber in communication with the clean-air pipe of the one of the turbochargers and the clean-air pipe of the other one of the turbochargers.

5. A method of operating two turbochargers in an arrangement with a combustion engine, said method comprising:
feeding clean air to each of the two turbochargers from a separate clean-air filter; and
equalizing a pressure of clean air fed to the turbochargers.

6. The method of claim 5, wherein the equalizing step is realized using pressure waves.

7. The method of claim 5, wherein the equalizing step is realized using an air mass flow.
